(19) United States
(12) Patent Application Publication
(10) Pub. No.: US 2003/0103062 A1
(43) Pub. Date: Jun. 5, 2003

(54) Apparatus and method for controlling a stereo 3D display using overlay mechanism

(76) Inventors: Ruen-Rone Lee, Hsinchu (TW); Li-Shu Lu, Taoyuan (TW); Shih-Chin Lin, Taipei (TW)

Correspondence Address: BIRCH STEWART KOLASCH & BIRCH, PO BOX 747, FALLS CHURCH, VA, 22040-0747, US

(21) Appl. No.: 09/996,803

(22) Filed: Nov. 30, 2001

(51) Int. Cl. G09G 5/00

(52) U.S. Cl. 345/629; 345/419

(57) ABSTRACT

An apparatus for controlling a display, which includes an on-screen buffer, two overlay buffers and a stereo window controller. The on-screen buffer stores screen image data that includes image data of an overlay region. The two overlay buffers are of a double-buffered architecture, and one overlay buffer stores the left image data and the right image data of a current frame, and another overlay buffer stores the left image data and the right image data of a next frame. The stereo window controller controls swap operations and overlay operations, wherein the swap operations determine which one of the two overlay buffers stores the left image data and the right image data of the current frame, and the overlay operations alternatively output the left image data and the right image data of the current frame while the overlay region is being scanned.

### BACKGROUND OF THE INVENTION

1. Field of the Invention

The invention relates to an apparatus and method of controlling a display and, in particular, to an apparatus and method for controlling a stereo 3D display using an overlay mechanism.

2. Related Art

In order that a viewer can view a scene correctly using a stereo 3D effect, two eyes of the viewer must see the scene from a slightly different perspective respectively. Each eye, in reality and in virtual reality, sees a different image of view. Then, after the mind “fuses” the two different images observed by different eyes, the observer sees a 3D stereoscopic image. There are some techniques that can be used to make sure each eye sees the image that was created for it, that is, the left eye sees the left image, and the right eye sees the right image. Take a synchronized shutter glasses for example, the wearer looks through the LCD shutter glasses while the LCD “shutters” on and off, alternately showing the left eye only the left image, and the right eye only the right image. If the system is properly designed, the shutter switches on and off so quickly that one's mind fuses the two images into a single stereoscopic image.

When it comes to stereo 3D animation, a plurality of frames are displayed for the viewer in sequence, and each frame has a left image and a right image. Referring to FIG. 9 and FIG. 10, a conventional 3D animation technique provides two memory blocks 51 and 52 with full-screen sizes in the video memory of a video card. The memory blocks 51 and 52 store a left image and a right image respectively, and the image shown on the display is alternatively referred to the left image stored in the memory block 51 and the right image stored in the memory block 52. FIG. 9 shows the situation of the image shown on the display, referred to the left image stored in the memory block 51, and FIG. 10 shows the situation of the image shown on the display, referred to the right image stored in the memory block 52.

While displaying different images, a synchronized shutter glasses 2 performs a switching operation synchronously, so that the left eye of a viewer views only the left image, and the right eye of the viewer views only the right image.

One disadvantage of the above-mentioned conventional technique is that the stereo 3D animation is displayed in full screen mode on a display, and cannot be displayed in a window under an OS window environment. That is because the memory blocks 51 and 52 are of full-screen sizes, and all left images and right images of the animation are full-screen images, the screen cannot display other windows or icons on the display while displaying the stereo 3D animation.

Due to the limitation that only full-screen mode can be displayed, the stereo 3D animation displayed using conventional method cannot be used in conjunction with other software applications. For example, while designing a new mechanism using a CAD system, the engineer may simulate the dynamic characteristics and conditions of the mechanism using the stereo 3D animation in one window, and tuning various parameters of the mechanism according to the simulation result in another window. If those two windows can be displayed simultaneously, the engineer can monitor the simulation and tune the design parameters at the same time, which reduces the time required for designing the mechanism significantly. However, since the stereo 3D animation in the prior art must be displayed in full-screen mode, the animation window and the parameter-analyzing window cannot be displayed at the same time.

### SUMMARY OF THE INVENTION

In view of the above, an objective of the invention is to provide an apparatus and method for controlling a display so that a stereo 3D animation can be displayed in a window.

To achieve the above-mentioned objective, the apparatus for controlling a display according to the invention includes an on-screen buffer, two overlay buffers and a stereo window controller. The on-screen buffer stores screen image data, which includes image data of an overlay region. The overlay buffers are of a double-buffer architecture, wherein one overlay buffer stores the left image data and the right image data of a current frame, and another overlay buffer stores the left image data and the right image data of the next frame of the current frame. The stereo window controller controls swap operations and the overlay mechanism. The swap operations determine which one of the two overlay buffers stores the left image data and the right image data of the current frame, and the overlay mechanism alternatively output the left image data and the right image data of the current frame while the overlay region is scanned.

In one aspect of the invention, the apparatus for controlling a display according to the invention further includes a 3D graphics engine for preparing the left image data and the right image data of the next frame. The stereo window controller controls the swap operations according to swap signals from the 3D graphics engine.

In another aspect of the invention, the stereo window controller considers vertical retraces of the display while controlling the swap operations.

In still another aspect of the invention, the stereo window controller further includes an overlay region detector and a selector. The overlay region detector judges if a scanning point enters the overlay region. The selector selects pixel data from the on-screen buffer or the overlay buffer storing the left image data and the right image data of the current frame according to the judging result of the overlay region detector. The overlay region detector judges whether the scanning point enters the overlay region according to the coordinates or the color of the scanning point.

The invention also provides a method for controlling a display, which stores the left image data and the right image data of a current frame in an overlay buffer, and prepares the left image data and the right image data of the next frame of the current frame in another overlay buffer. The method according to the invention alternatively outputs the left image data and the right image data of the current frame when the overlay region is scanned. After the left image data and the right image data of the next frame is fully prepared, the method according to the invention performs a swap operation to swap the overlay buffer storing the left image data and the right image data of the current frame

By utilizing the double buffer architecture and using the stereo window controller to coordinate the buffer swap operations, the overlay mechanism and the vertical retraces, the apparatus and method for controlling a display according to the invention can display a stereo 3D animation in a window.

### BRIEF DESCRIPTION OF THE DRAWINGS

These and other features, aspects and advantages of the invention will become better understood with regard to the following description, appended claims and accompanying drawings, wherein:

FIG. 1 is a schematic block diagram showing the architecture of the apparatus for controlling a display according to a preferred embodiment of the invention;

FIG. 2 is a flowchart showing the procedure of the method for controlling a display according to a preferred embodiment of the invention;

FIG. 3 is a schematic diagram showing the condition that the pixel data is output from the on-screen buffer when the scanning point is not in the overlay region;

FIG. 4 is a schematic diagram showing the condition that the pixel data is output from the overlay buffer when the scanning point is in the overlay region;

FIG. 5 is a schematic diagram showing that the overlay region detector judges whether the scanning point enters the overlay region according to the coordinates set by the scanning point;

FIG. 6 is a schematic diagram showing that the overlay region detector judges whether the scanning point enters the overlay region depending on the color of the scanning point;

FIG. 7 and FIG. 8 are schematic diagrams showing the conditions for displaying a stereo 3D animation according to a preferred embodiment of the invention; and

FIG. 9 and FIG. 10 are schematic diagrams showing the conditions for displaying a stereo 3D animation in the prior art.

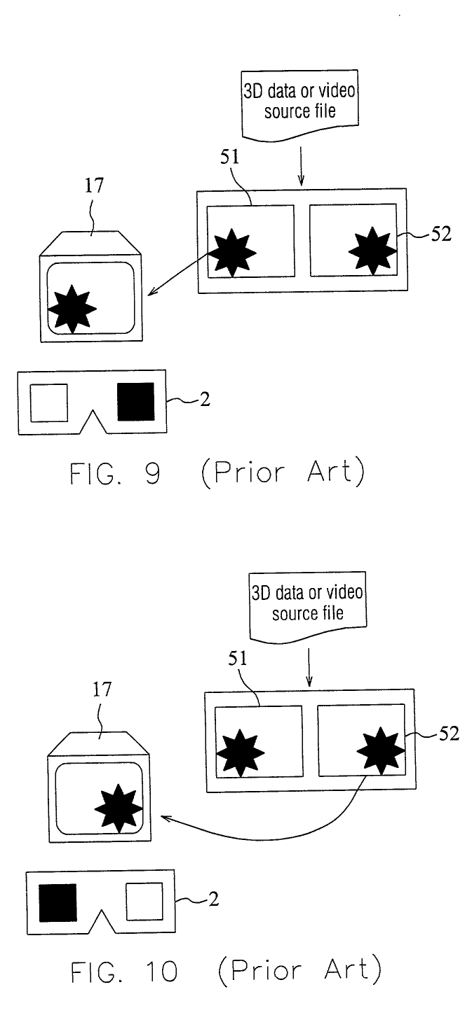

### DETAILED DESCRIPTION OF THE PREFERRED EMBODIMENT

The apparatus and method for controlling a display according to a preferred embodiment of the invention will be apparent from the following detailed description, wherein the same reference numerals relate to the same elements.

### Hardware Architecture Overview

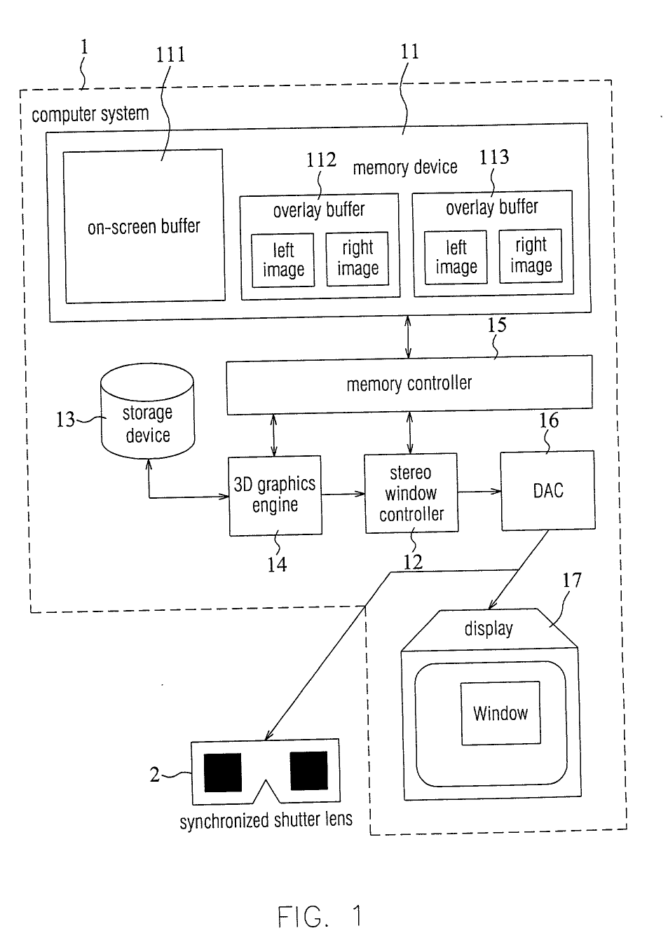

Referring to FIG. 1, the apparatus for controlling a display according to the preferred embodiment of the invention includes a memory device 11 and a stereo window controller 12. The memory device 11 includes an on-screen buffer 111 and two overlay buffers 112 and 113. The on-screen buffer 111 stores image data to be shown on the display 17. The data includes image data of an overlay region.

In the preferred embodiment, the overlay region refers to the area on the display 17 showing the animation. The image data of the overlay region are only a part of the image data to be displayed on the display 17. In other words, besides the image data of the overlay region, the on-screen buffer 111 can store data of other images, such as the image data for another window, icon or wallpaper.

In the preferred embodiment, the apparatus 10 is implemented in a computer system 1. The computer system 1, co-operating with a synchronized shutter glasses 2, includes a storage device 13, a 3D graphics engine 14, a memory controller 15 and a DAC (Digital Analog Converter) 16.

The storage device 13 can be any kind of primary or secondary computer-readable storage device, such as a hard disc drive, a CD drive or a DVD drive, and can be connected to the other devices in the computer system 1 via data transmission buses.

The 3D graphics engine 14 transforms 3D data or data of other video file formats to left image data and right image data according to stereo 3D image processing principles. The 3D graphics engine 14 can be a functional module on a video card or a software module stored in the computer system 1.

The memory controller 15 controls the data access and transfer operations in the memory device 11. The memory controller 15 consists of specific circuitry, which interprets requests from other devices in the computer system 1, and locates data addresses in the memory to read/write data from/to the memory device 11.

The DAC 16 transforms the digital image data stored in the on-screen buffer 111 into analog signals, the analog signal is output on the display 17. At the same time, the DAC 16 sends a synchronization signal to the synchronized shutter lens 2, so that the vertical retrace can be synchronized with the alternative on-off operations of the left and right shutters of the synchronized shutter lens 2.

It should be noted that one might integrate the memory device 11 and the stereo window controller 12 together with the 3D graphics engine 14, the memory controller 15 and the DAC 16 on a video card or in a chipset. The person skilled in the art could implement various designs without departing from the scope of the invention.

In the preferred embodiment, the memory device 11 is provided with a double-buffer architecture to enhance the data-processing efficiency. The memory device 11 has two overlay buffers 112 and 113. One overlay buffer stores the left image data and the right image data of a current frame, and another overlay buffer stores the left image data and the right image data of the next frame of the current frame. The detailed descriptions regarding the off-screen buffers will be given later.

The stereo window controller 12 controls the swap operations of the two off-screen buffers 112 and 113 and the overlay operations of the left image data and the right image data of the current frame. The detailed descriptions regarding the stereo window controller 12 will also be given later.

### Animation Playing Procedure Overview

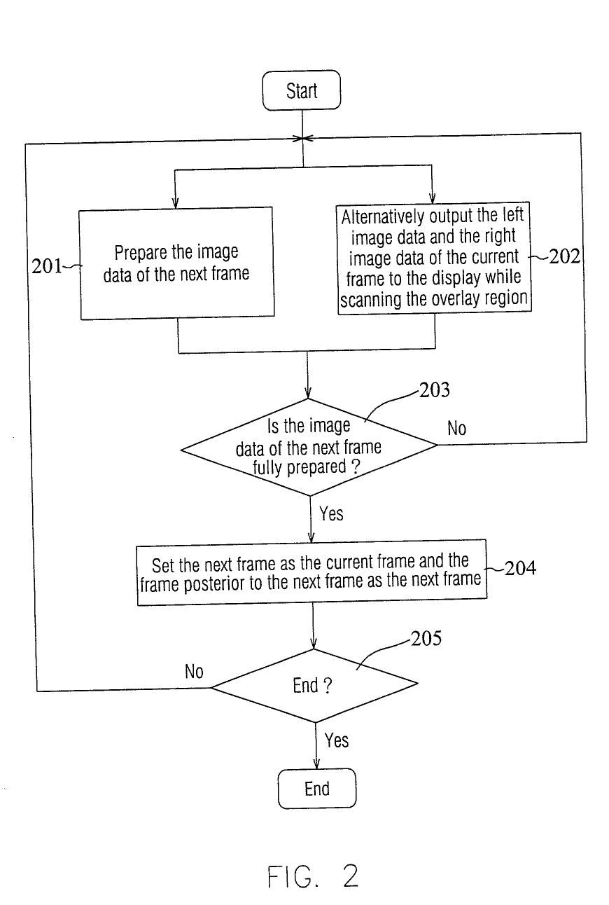

Referring to FIG. 2, in the method for controlling a display according to the preferred embodiment of the invention, the left image data and the right image data of the current frame are stored in one off-screen buffer, and the left image data and the right image data of the next frame are stored in another off-screen buffer in step 201.

In the preferred embodiment, the 3D data or a video source file stored in the storage device 13 are transferred to the 3D graphics engine 14 via buses. The 3D graphics engine 14 then prepares the left image data and the right image data of each frame according to the 3D stereo image principle. Once a frame is fully prepared, the 3D graphics engine 14 prepares its next frame.

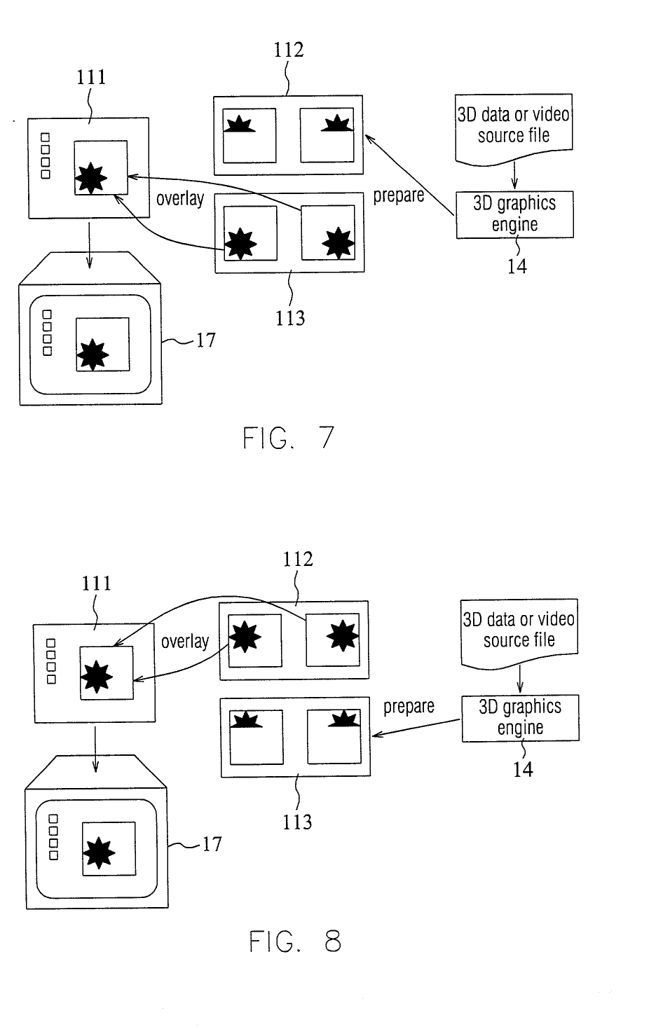

The stereo window controller 12 determines which off-screen buffer stores the data of the current frame, and which buffer stores the data of the next frame. The 3D graphics engine 14 writes the data of the next frame under preparation to the off-screen buffer the stereo window controller 12 directed through the memory controller 15. For example, referring to FIG. 7 and FIG. 8, when the image data of the current frame is stored in the off-screen buffer 113, the stereo window controller 12 directs the image data of the next frame under preparation to be stored in the off-screen buffer 112 (as shown in FIG. 7). When the image data of the current frame is stored in the off-screen buffer 112, the stereo window controller 12 directs the image data of the next frame under preparation to be stored in the off-screen buffer 113 (as shown in FIG. 8).

In step 202, the left image data and the right image data of the current frame are output to the display 17 alternatively while scanning the overlay region. That is, while scanning the overlay region, the left image data and the right image data of the current frame stored in the overlay buffer are used to “overlay” the image data stored in the on-screen buffer. The detailed descriptions about the overlay operation will be given later.

Step 203 judges if the image data of the next frame is fully prepared in the overlay buffer. If the image data of the next frame is not fully prepared, the method returns to steps 201 and 202 mentioned above. If the image data of the next frame is fully prepared, the method proceeds to step 204, wherein a swap operation is performed to set the next frame as the current frame and the frame posterior to the next frame as the next frame.

Step 205 judges whether or not the whole procedure comes to end. For example, if the user inputs a “stop” request to stop playing the animation, or the last frame of the animation has been processed, then the whole stereo 3D control method ends. Otherwise, the method returns to steps 201 and 202.

### Overlay Mechanism

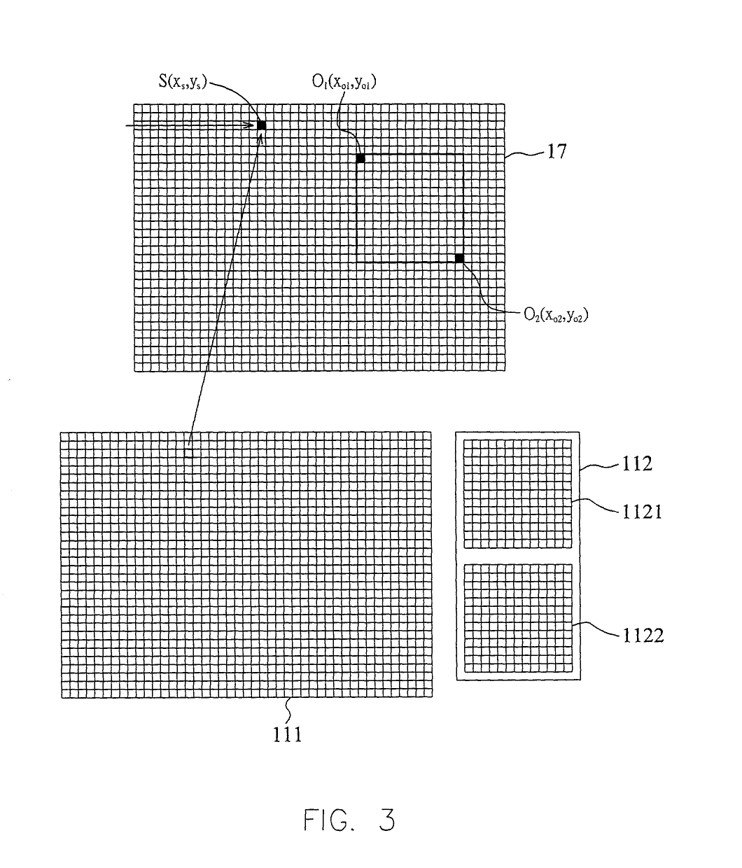

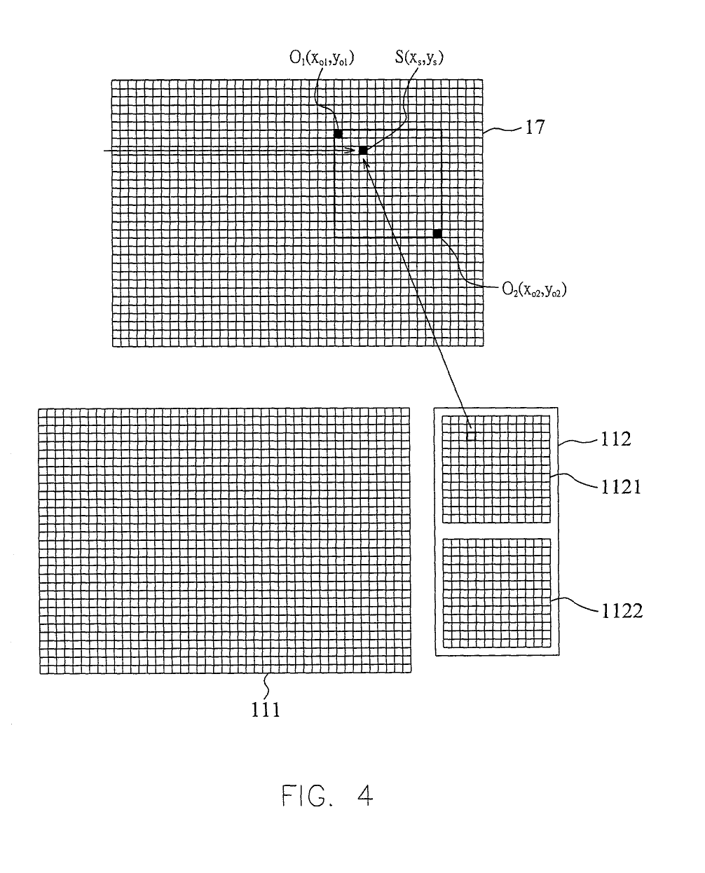

Referring to FIG. 3 and FIG. 4, in the preferred embodiment, when the display 17 outputs an image, the pixels of the display screen are scanned one by one from the top left pixel to bottom right pixel. While scanning a pixel, the image data stored in the on-screen buffer 111 corresponding to the pixel being scanned are transferred to DAC 16, so that the image data of the pixel scanned can be transformed into analog signals to output to the display 17.

In FIG. 3 and FIG. 4, the scanning point S refers to the pixel scanned, and the points O₁ and O₂ are the top-left point and the bottom-right point of the overlay region, respectively. As shown in FIG. 3, when the scanning point S is not in the overlay region, the pixel data are read from the corresponding addresses of the on-screen buffer 111. As shown in FIG. 4, when the scanning point S is in the overlay region, the pixel data are read from the corresponding addresses of the overlay buffer 112.

In FIG. 3 and FIG. 4, the image data of the current frame is stored in the overlay buffer 112, and the image data to be output is the left image 1121. If the image data of the current frame is stored in another overlay buffer 113 or the image data to be output is the left image 1122, the pixel data will be output from other corresponding addresses.

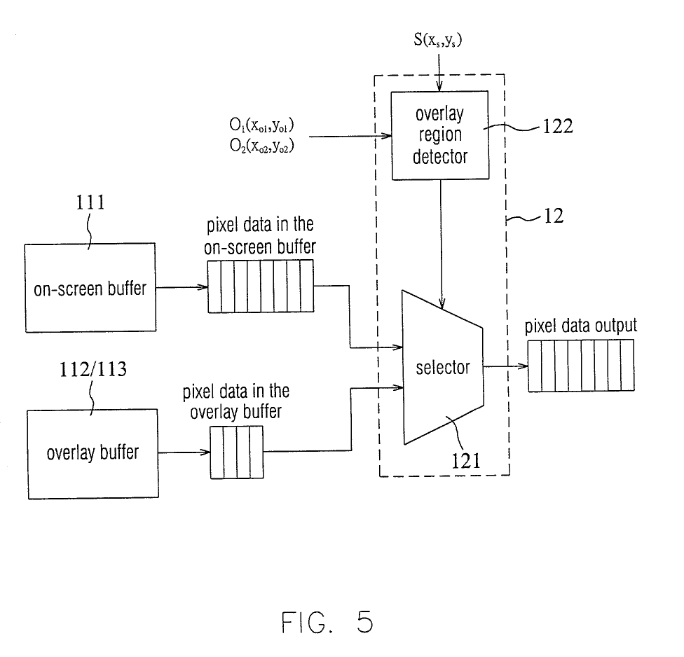

Referring to FIG. 5, in the preferred embodiment, the stereo window controller 12 judges whether the scanning point S is in the overlay region. The stereo window controller 12 includes a selector 121 and an overlay region detector 122. In one aspect of the preferred embodiment, the overlay region detector 122 judges whether the scanning point enters the overlay region according to the coordinates of the scanning point. That is, the overlay region detector 122 judges whether the scanning point S (xₛ,yₛ) and the points O₁ (xₒ₁,yₒ₁) and O₂ (xₒ₂,yₒ₂) satisfy the following relationship:

xₒ₁≦xₛ≦xₒ₂ and yₒ₁≦yₛ≦yₒ₂

If the scanning point S and the points O₁ and O₂ do not satisfy this relationship, the overlay region detector 122 knows that the scanning point S is not in the overlay region. Then, the selector 121 selects the pixel data stored in the on-screen buffer 111. On the contrary, if the scanning point S and the points O₁ and O₂ satisfy this relationship, the overlay region detector 122 knows that the scanning point S is in the overlay region. Then, the selector 121 selects the pixel data stored in the overlay buffer 112.

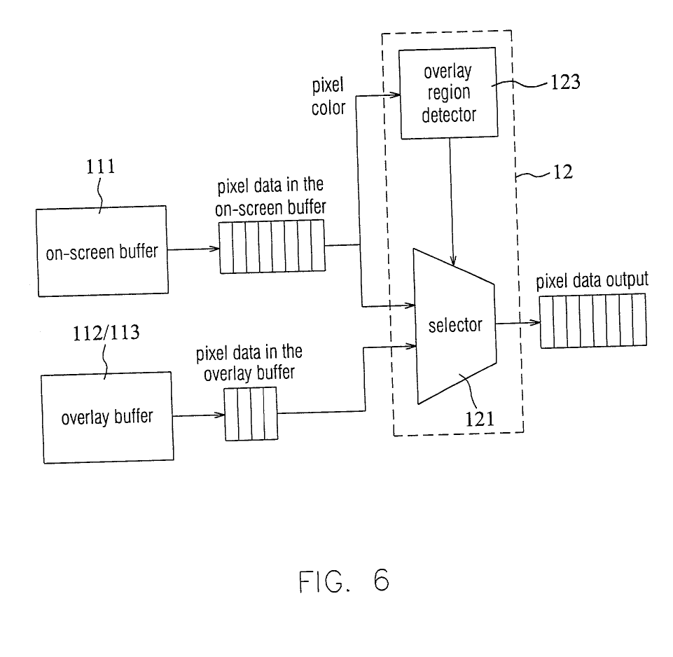

Referring to FIG. 6, another way for the overlay region detector 122 to judge whether the scanning point S is in the overlay region is to check if the color of the scanning point is an overlay color. The color values of the pixels in the overlay region stored in the on-screen buffer 111 are preset to the overlay color. Then, when scanning the on-screen buffer, the overlay region detector 122 judges whether the color of the scanning point S is the overlay color. If so, then the selector 121 selects the pixel data stored in the overlay buffer 112. If not, then the selector 121 selects the pixel data stored in the on-screen buffer 111.

When the scanning point S is the last pixel of the screen (i.e., the bottom-right pixel in FIG. 3 and FIG. 4), the display 17 performs a vertical retrace to return to the first pixel (i.e., the top-left pixel in FIG. 3 and FIG. 4). At this time, the stereo controller 12 determines which overlay buffer outputs for the next image shown in the overlay region, and whether the next output image data should be the left image data or the right image data.

To sum up, the stereo window controller coordinates the following:

(1) determining which one of the two off-screen buffers stores the left image data and the right image data of the current frame;

(2) judging if the scanning point enters the overlay region;

(3) alternatively outputting the left image data or the right image data; and

(4) the vertical retraces of the display.

Therefore, the apparatus and method for controlling a display according to the preferred embodiment of the invention can display a stereo 3D animation in a window.

While the invention has been described with reference to a preferred embodiment, this description is not intended to be construed in a limiting sense. Various modifications of the embodiment will be apparent to persons skilled in the art upon reference to the description. It is therefore intended that the appended claims encompass any such modifications.

What is claimed is:

1. An apparatus for controlling a display, comprising:
an on-screen buffer for storing screen image data, the screen image data comprising image data of an overlay region;
two overlay buffers with double-buffer architecture, wherein one overlay buffer stores the left image data and the right image data of a current frame, and another overlay buffer stores the left image data and the right image data of the next frame of the current frame; and
a stereo window controller for controlling swap operations and overlay operations, wherein the swap operations determine which of the two overlay buffers stores the left image data and the right image data of the current frame, and the overlay operations alternatively output the left image data and the right image data of the current frame when the overlay region is scanned.

2. The apparatus according to claim 1, further comprising:
a 3D graphics engine for preparing the left image data and the right image data of the next frame.

3. The apparatus of claim 2, wherein the stereo window controller controls the swap operations according to swap signals from the 3D graphics engine.

4. The apparatus according to claim 1, wherein the stereo window controller considers vertical retraces of the display while controlling the swap operations.

5. The apparatus according to claim 1, wherein the stereo window controller further comprises:
an overlay region detector for judging if a scanning point enters the overlay region according to the coordinates of the scanning point; and
a selector for selecting pixel data from one of the on-screen buffer and the overlay buffer storing the left image data and the right image data of the current frame according to the judging result of the overlay region detector.

6. The apparatus according to claim 1, wherein the stereo window controller further comprises:
an overlay color detector for judging if the color of a scanning point is an overlay color; and
a selector for selecting pixel data from one of the on-screen buffer and the overlay buffer storing the left image data and the right image data of the current frame according to the results of the overlay color detector.

7. A method for controlling a display, comprising:
storing the left image data and the right image data of a current frame in one of two overlay buffers of a double-buffer architecture;
preparing the left image data and the right image data of the next frame of the current frame in another one of the two overlay buffers;
alternatively outputting the left image data and the right image data of the current frame when the overlay region is scanned; and
performing a swap operation to swap the overlay buffer storing the left image data and the right image data of the current frame after the left image data and the right image data of the next frame is fully prepared.

8. The method according to claim 7, further comprising:
considering vertical retraces of the display while selecting one of the overlay buffers.

9. The method according to claim 7, further comprising:
judging if a scanning point enters the overlay region according to the coordinates of the scanning point; and
selecting pixel data from one of the on-screen buffer and the overlay buffer storing the left image data and the right image data of the current frame according to the judging result.

10. The method according to claim 7, further comprising:
judging if the color of a scanning point is an overlay color; and
selecting pixel data from one of the on-screen buffer and the overlay buffer storing the left image data and the right image data of the current frame according to the judging result.

11. The method according to claim 7, further comprising:
setting the next frame as the current frame; and
setting the frame posterior to the next frame as the next frame.

12. A video card, comprising:
an on-screen buffer for storing screen image data, the screen image data comprises image data on an overlay region;
two overlay buffers of a double-buffer architecture, wherein one overlay buffer stores the left image data and the right image data of a current frame, and another overlay buffer stores the left image data and the right image data of the next frame of the current frame;
a 3D graphics engine for preparing the left image data and the right image data of the next frame; and
a stereo window controller for controlling swap operations and overlay operations, wherein the swap operations determine which of the two overlay buffers stores the left image data and the right image data of the current frame, and the overlay operations alternatively output the left image data and the right image data of the current frame when the overlay region is scanned.

13. The video card according to claim 12, wherein the stereo window controller controls the swap operations according to swap signals from the 3D graphics engine.

14. The video card according to claim 12, wherein the stereo window controller considers vertical retraces of a display while controlling the overlay operations.

15. The video card according to claim 12, wherein the stereo window controller further comprises:
an overlay region detector for judging if a scanning point enters the overlay region according to the coordinates of the scanning point; and
a selector for selecting pixel data from one of the on-screen buffer and the overlay buffer storing the left image data and the right image data of the current frame according to the judging result of the overlay region detector.

16. The video card according to claim 12, wherein the stereo window controller further comprises:
an overlay region detector for judging if a scanning point enters the overlay region according to whether the color of the scanning point is an overlay color; and
a selector for selecting pixel data from one of the on-screen buffer and the overlay buffer storing the left image data and the right image data of the current frame according to the judging result of the overlay color detector.

17. A computer system, comprising:
a display; and
a video card, which comprises:
an on-screen buffer for storing screen image data, the screen image data comprises image data of an overlay region;
two overlay buffers of a double-buffer architecture, wherein one overlay buffer stores the left image data and the right image data of a current frame, and another overlay buffer stores the left image data and the right image data of the next frame of the current frame;
a 3D graphics engine for preparing the left image data and the right image data of the next frame; and
a stereo window controller for controlling swap operations and overlay operations, wherein the swap operations determine which of the two overlay buffers stores the left image data and the right image data of the current frame, and the overlay operations alternatively output the left image data and the right image data of the current frame when the overlay region is scanned,
wherein the stereo window controller controls the swap operations according to swap signals from the 3D graphics engine; and
wherein the stereo window controller considers vertical retraces of the display while controlling the swap operations.

18. The computer system according to claim 17, wherein the stereo window controller further comprises:
an overlay region detector for judging if a scanning point enters the overlay region according to the coordinates of the scanning point; and
a selector for selecting pixel data from one of the on-screen buffer and the overlay buffer storing the left image data and the right image data of the current frame according to the judging result of the overlay region detector.

19. The computer system according to claim 17, wherein the stereo window controller further comprises:
an overlay color detector for judging if the color of a scanning point is an overlay color; and
a selector for selecting pixel data from one of the on-screen buffer and the overlay buffer storing the left image data and the right image data of the current frame according to the judging result of the overlay color detector.

20. A stereo window controller for controlling swap operations and overlay operations in a computer system, the computer system including a display, an on-screen buffer for storing screen image data that comprises image data of an overlay region, two overlay buffers in which one overlay buffer stores the left image data and the right image data of a current frame and another overlay buffer stores the left image data and the right image data of the next frame of the current frame, and a 3D graphics engine for preparing the left image data and the right image data of the next frame,
the stereo window controller comprising:
an overlay region detector for judging if a scanning point enters the overlay region; and
a selector for selecting pixel data from one of the on-screen buffer and the overlay buffer storing the left image data and the right image data of the current frame according to the judging result of the overlay region detector,
wherein the swap operations determine which of the two overlay buffers stores the left image data and the right image data of the current frame, and the overlay operations alternatively output the left image data and the right image data of the current frame while scanning the overlay region.

21. The stereo window controller according to claim 21, wherein the overlay region detector judges whether the scanning point enters the overlay region according to the coordinates of the scanning point.

22. The stereo window controller according to claim 21, wherein the overlay region detector judges whether the scanning point enters the overlay region according to whether the color of the scanning point is an overlay color.
